(19) United States
(12) Patent Application Publication
(10) Pub. No.: US 2021/0125102 A1
(43) Pub. Date: Apr. 29, 2021

(54) INFORMATION PROCESSING SYSTEM, INFORMATION PROCESSING APPARATUS, AND INFORMATION PROCESSING PROGRAM

(71) Applicant: FUJITSU LIMITED, Kawasaki-shi (JP)

(72) Inventor: HIROKI OHTSUJI, Yokohama (JP)

(73) Assignee: FUJITSU LIMITED, Kawasaki-shi (JP)

(21) Appl. No.: 17/029,104

(22) Filed: Sep. 23, 2020

(30) Foreign Application Priority Data
Oct. 28, 2019 (JP) 2019-195560

(51) Int. Cl. G06N 20/00; G06F 9/52; G06N 5/04

(52) U.S. Cl. CPC G06N 20/00; G06N 5/04; G06F 9/52

(57) ABSTRACT

An information processing system includes: a storage device configured to store a plurality of pieces of learning data; and a plurality of computation nodes each configured to read learning target learning data from the storage device, determine whether or not a delay in reading the learning target learning data has occurred, based on a reading status, and when determining that the delay in reading has occurred, perform machine learning by synchronous parallel processing using alternative learning data previously read from the storage device.

### CROSS-REFERENCE TO RELATED APPLICATION

This application is based upon and claims the benefit of priority of the prior Japanese Patent Application No. 2019-195560, filed on Oct. 28, 2019, the entire contents of which are incorporated herein by reference.

### FIELD

The embodiments discussed herein are related to an information processing system, an information processing apparatus, and an information processing program.

### BACKGROUND

As a technology for learning a mass amount of data at high speed in an information processing system that performs machine learning (hereinafter, sometimes also simply referred to as a system), a technology that performs parallel processing with a plurality of computation nodes has been established. For example, in a case where the machine learning is deep learning, there is a technology called distributed deep learning.

Japanese Laid-open Patent Publication No. 2018-018220, Japanese Laid-open Patent Publication No. 2019-109875, Japanese Laid-open Patent Publication No. 2018-206016, and Japanese Laid-open Patent Publication No. 2018-120441 are disclosed as related art.

### SUMMARY

According to an aspect of the embodiments, an information processing system includes: a storage device configured to store a plurality of pieces of learning data; and a plurality of computation nodes each configured to read learning target learning data from the storage device, determine whether or not a delay in reading the learning target learning data has occurred, based on a reading status, and when determining that the delay in reading has occurred, perform machine learning by synchronous parallel processing using alternative learning data previously read from the storage device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating exemplary machine learning processing of an information processing system according to a first embodiment;

FIG. 2 is a diagram illustrating an exemplary information processing system that performs distributed deep learning;

FIG. 3 is a diagram illustrating exemplary hardware of a computation node;

FIG. 4 is a diagram illustrating an exemplary procedure of distributed deep learning;

FIG. 5 is a diagram illustrating an exemplary procedure of distributed deep learning in a case where processing of taking a measure against a data reading delay is not involved;

FIG. 6 is a block diagram illustrating a machine learning function in computation nodes;

FIG. 7 is a diagram illustrating an exemplary alternative data use list;

FIG. 8 is a diagram illustrating an exemplary reading delay data list,

FIG. 9 is a diagram for explaining distributed deep learning processing that involves the measurement of learning data reading time;

FIG. 10 is a flowchart illustrating an exemplary learning processing procedure in a computation node within one epoch;

FIG. 11 is a flowchart illustrating an exemplary procedure of alternative data selection processing;

FIG. 12 is a diagram illustrating exemplary computation nodes regarded as adjacent nodes;

FIG. 13 is a flowchart illustrating an exemplary procedure of common weight update value calculation processing;

FIG. 14 is a diagram illustrating an exemplary method of specifying a threshold value for detecting a reading delay; and

FIG. 15 is a diagram illustrating an exemplary distributed deep learning procedure that involves a measure to restrain a learning delay against a data reading delay.

### DESCRIPTION OF EMBODIMENTS

The parallel processing in the machine learning includes synchronous parallel learning. In the synchronous parallel processing, the system specifies a unified update amount for the value of a parameter set in a learning model at a predetermined synchronization timing, based on the learning result in each computation node. Then, each computation node updates the value of the parameter set in the learning target model (for example, a neural network) with the specified update amount.

As a technology relating to parallel processing, for example, a parallel information processing apparatus that shortens the time for processing of reflecting gradient information on a coefficient used for coefficient arithmetic operation in deep learning by inter-node parallelization has been proposed. Furthermore, a system capable of achieving high scalability in parallel distributed learning processing has also been proposed. In addition, a machine learning system capable of efficiently performing machine learning has also been proposed, which has been made in view of the fact that a transfer waiting state frequently produced due to the occurrence of a large amount of traffic between computation nodes is a bottleneck in shortening the learning time. Moreover, a distributed deep learning apparatus that attains both of the efficiency of computation and the reduction of communication volume has also been proposed.

In a system that performs synchronous parallel learning, there are cases where a non-predictable delay happens in some of the computation nodes when reading learning data. In these cases, learning in a computation node in which reading has been delayed is delayed. Then, a computation node in which learning is not delayed is expected to wait for the end of learning in the delayed computation node at the synchronization timing. As a result, learning in the system as a whole is delayed. For example, this allows the influence of data reading delay in some of the computation nodes to spread over the entire system, and degrades the learning performance of the system.

In one aspect, the degradation of learning performance caused by a delay in reading learning data may be restrained.

Hereinafter, the present embodiments will be described with reference to the drawings. Note that, each of the embodiments may be implemented in combination within a scope without contradiction.

### First Embodiment

First, a first embodiment will be described. In the first embodiment, when machine learning by synchronous parallel processing is performed by a plurality of computation nodes, a computation node that has predicted that a delay in reading learning data will occur implements a measure to restrain the degradation of learning performance due to reading delay. The degradation of learning performance means, for example, the degradation of the accuracy of the learning model after learning, or an extended duration of learning until a learning model with a predetermined accuracy is obtained.

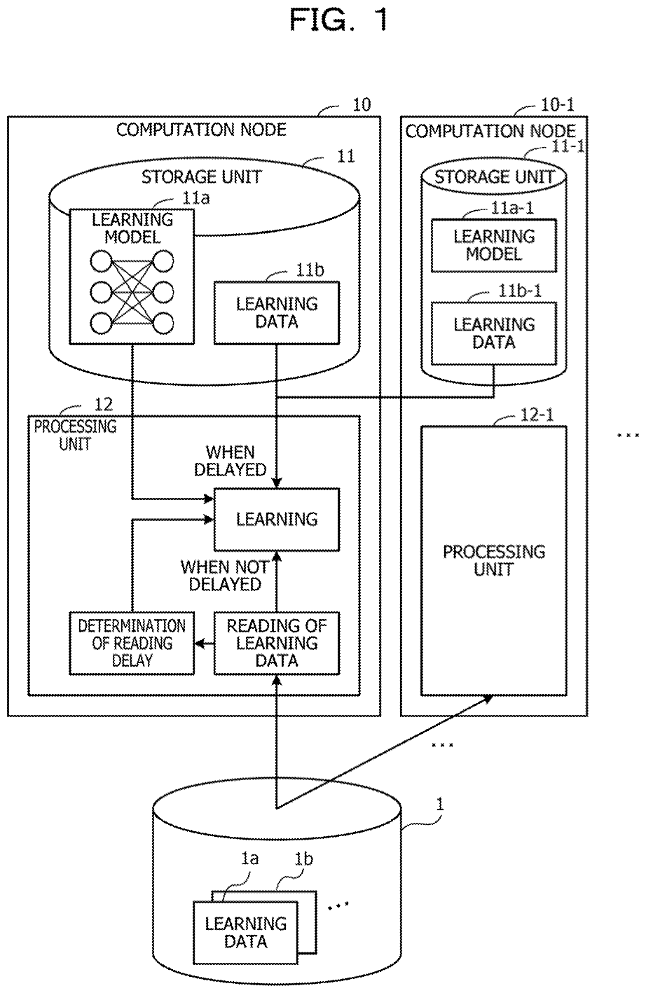

FIG. 1 is a diagram illustrating exemplary machine learning processing of an information processing system according to the first embodiment. The information processing system includes a storage device 1 and a plurality of computation nodes 10, 10-1, . . . . The storage device 1 stores a plurality of pieces of learning data 1a, 1b, . . . , and is shared by the plurality of computation nodes 10, 10-1, . . . . For example, each of the plurality of computation nodes 10, 10-1, . . . executes an information processing program in which a processing procedure of each computation node in machine learning is described, to thereby achieve machine learning.

The computation node 10 includes a storage unit 11 and a processing unit 12. The storage unit 11 is, for example, a memory included in the computation node 10 or a storage device. The processing unit 12 is, for example, a processor included in the computation node 10, or an arithmetic circuit. The computation node 10-1 likewise includes a storage unit 11-1 and a processing unit 12-1. The computation nodes that are not illustrated similarly include storage units and processing units.

The storage unit 11 stores a learning model 11a and learning data 11b. The learning model 11a is generated by machine learning and is a model obtained by modeling a course of generating output data according to input data. For example, when the machine learning is deep learning, the learning model 11a is equivalent to a neural network set with the value of a weight parameter for the input value to a node corresponding to a neuron.

The learning data 11b is learning data that has been read from the storage device 1 in the past The learning data stored in the storage unit 11 is, for example, learning data for which reading has been completed over the processing time in past learning data reading processing. Furthermore, in some cases, the learning data 11b is learning data that is stored in the storage unit 11 as cache data only for a fixed period and has already been used for learning.

As in the storage unit 11, the storage unit 11-1 of the computation node 10-1 also stores a learning model 11a-1 and learning data 11b-1. Learning models and the learning data are also stored in storage units of the computation nodes that are not illustrated.

The processing unit 12 reads learning target learning data from the storage device 1. In the synchronous parallel processing, the respective processing units 12 of the plurality of computation nodes 10, 10-1, . . . read different pieces of learning data from each other from the storage device 1 as learning targets at the same timing.

The processing unit 12 determines whether or not a delay in reading the learning target learning data has occurred, based on the reading status of the learning target learning data. For example, the processing unit 12 determines that a reading delay has occurred, in a case where the reading of the learning target learning data is not completed even when the elapsed time from the start of reading the learning target learning data reaches a predetermined threshold value. The threshold value is, for example, a time within which the reading of a predetermined percentage (for example, 90%) of the learning data is completed, which has been statistically worked out based on the time taken to complete the reading when the learning data was read in the past.

When it is determined that a reading delay has not occurred, the processing unit 12 performs machine learning by synchronous parallel processing using the learning target learning data read from the storage device 1. Furthermore, when it is determined that a reading delay has occurred, the processing unit 12 performs machine learning by synchronous parallel processing using alternative learning data previously read from the storage device 1. Hereinafter, a computation node in which a reading delay has occurred is referred to as a first computation node.

For example, when the computation node 10 becomes the first computation node, the processing unit 12 selects alternative data from among pieces of learning data 11b, 11b-1, . . . that have been read from the storage device 1 and stored in the past by a part of the plurality of computation nodes 10, 10-1, . . . . In that case, the processing unit 12 may select, as alternative data, learning data for which reading has been completed after it is determined that a reading delay has occurred in the preceding reading processing for the learning data in the first computation node (computation node 10), and is not yet used for learning. Furthermore, the processing unit 12 may also select, as alternative learning data, the learning data 11b-1 held by a computation node (hereinafter, referred to as a second computation node) that has a predetermined connection relationship with the first computation node (computation node 10). In this case, the processing unit 12 acquires the alternative learning data 11b-1 from the second computation node (for example, the computation node 10-1).

The processing unit 12 of the computation node 10, which is the first computation node, assigns, for example, a computation node connected to the same switch as the computation node 10, as the second computation node. In addition, for example, when the plurality of computation nodes 10, 10-1, . . . contains a plurality of pieces of learning data that is allowed to be assigned as alternative learning data, the processing unit 12 may also select, as alternative learning data, learning data that has the smallest number of times of being used for learning.

Note that processing similar to processing of the processing unit 12 is performed also in the processing units (the processing unit 12-1 and the like) of the computation nodes 10-1, . . . other than the computation node 10.

In this manner, the computation node in which a delay in reading the learning target learning data has occurred may perform the learning using the alternative learning data without waiting for the completion of reading of the delayed learning data. Consequently, even if the reading of the learning data is delayed in some of the computation nodes, the occurrence of delay in learning in the some of the computation nodes may be restrained. As a result, a delay in reading the learning data in some of the computation nodes may be restrained from causing a delay in machine learning in the information processing system as a whole.

Besides, in the computation node in which the reading of the learning data is delayed, the learning is not skipped but the learning is performed using the alternative learning data. Therefore, this computation node may also contribute to the improvement of the accuracy of the learning model. As a result, the time expected for the learning model 11a to reach a desired accuracy may be restrained from extending. For example, this restrains the degradation of learning performance caused by a delay in reading the learning data.

Note that the alternative learning data may be read quickly by the computation node in which the reading of the learning data is delayed, by selecting alternative learning data from among pieces of learning data that have been read from the storage device 1 and stored in the past by a part of the plurality of computation nodes. For example, even if accesses to read learning data are made from the plurality of computation nodes 10, 10-1, . . . , and a high processing load status is brought about in the storage device 1, communication between computation nodes that have a predetermined connection relationship that allows high-speed communication may be executed at high speed. Therefore, even when a computation node in which the reading of the learning target learning data is delayed is caused to read the alternative learning data from another computation node, the alternative learning data may be read in a short time.

However, if the distance between a computation node in which the reading of the learning data is delayed and a computation node having the alternative learning data is too long on the network, there is a possibility that it takes a long time to read the alternative data. Thus, for example, by limiting the destination from which the alternative data is acquired, to a computation node directly connected to the same switch as the computation node in which the reading of the learning data is delayed, a delay in reading the alternative data may be restrained. Note that direct connection of the computation node to the switch means that the computation node is connected without passing through a communication device such as another switch.

Furthermore, by causing the computation node in which the reading of the learning data is delay to select unlearned learning data as substitute learning data, the degree of contribution of this computation node to the improvement in the accuracy of the learning model by learning may be improved. Similarly, by causing the computation node in which the reading of the learning data is delayed to select learning data with the smallest number of times of being used for learning, as alternative learning data, the degree of contribution of this computation node to the improvement in the accuracy of the learning model by learning may also be improved.

Note that, when there is no learning data that is allowed to be assigned as alternative learning data, the computation node in which the reading of the learning data is delayed may also skip learning until the next learning data reading timing. In this case, in distributed learning, the number of pieces of learning data used for learning is decreased. When the number of pieces of learning data used for learning is decreased, the computation nodes 10, 10-1, . . . may shrink the modification amount of the weight parameter of the learning model according to the decreased number of pieces of learning data.

For example, in the synchronous parallel learning, a specific computation node acquires weight update values obtained as the learning results from all the computation nodes 10, 10-1, . . . after fixed cycles of learning processing end. The weight update value is a modification value (a difference between before modification and after modification) of the weight parameter set in the learning model. The computation node that has acquired the weight update values works out a representative value such as the average value of the weight update values, and calculates a unified weight update value (common weight update value) among all the computation nodes 10, 10-1, . . . , based on the representative value. At this time, when a computation node that has skipped learning is included, as compared to when no computation node that has skipped learning is included, the accuracy (whether or not the learning model can be modified precisely) of the representative value such as the average value of the weight update values collected from the computation nodes 10, 10-1, . . . deteriorates.

Thus, the computation node that has collected the weight update values may calculate the common weight update value according to the number of pieces of learning data used for learning in computation nodes that have executed learning without skipping. For example, the computation node that has collected the weight update values employs, as the common weight update value, a value obtained by multiplying the average of the weight update values computed by the respective computation nodes that have executed learning without skipping, by a larger value (a real number equal to or smaller than one) as the number of pieces of learning data used for learning grows larger. Then, the computation nodes 10, 10-1, . . . update the values of the weight parameters set in the respective learning models included in the plurality of computation nodes, by the common weight update value reflecting the number of pieces of learning data used for learning.

In this manner, by updating the value of the weight parameter of the learning model with an appropriate common weight update value according to the number of pieces of learning data used for learning, the accuracy of the learning model may be efficiently improved.

Note that the processing unit 12 may also determine that a reading delay has occurred, before the time from the start of reading the learning data reaches the threshold value. For example, the processing unit 12 may determine that a reading delay has occurred, in a case where the amount of data that has already been read at the time point when a time equivalent to a predetermined percentage (for example, 90%) of the threshold value has elapsed from the start of reading is equal to or less than a predetermined percentage (for example, 60%) of the learning data. By thus finding the occurrence of the reading delay at an earlier stage, the alternative data may be read with a margin.

### Second Embodiment

Next, a second embodiment will be described. The second embodiment is intended to restrain the degradation of learning performance caused by a delay in reading the learning data in an information processing system that implements the distributed deep learning by synchronous parallel processing.

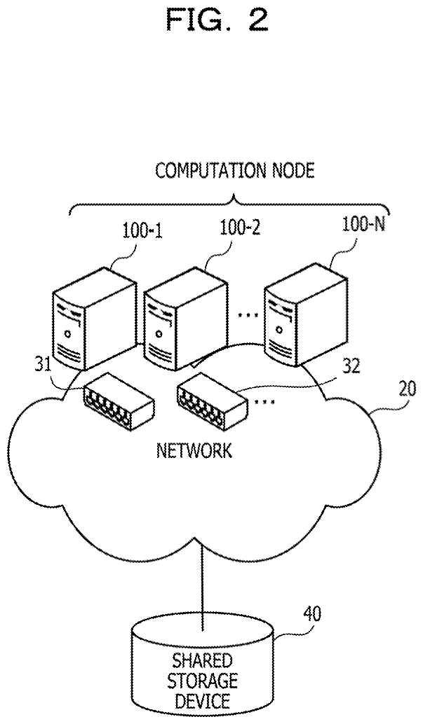

FIG. 2 is a diagram illustrating an exemplary information processing system that performs the distributed deep learning. In distributed deep learning, a plurality of computation nodes 100-1, 100-2, . . . , and 100-N executes learning processing in parallel. In the example in FIG. 2, it is assumed that there are N (N is an integer equal to or greater than two) computation nodes. Identifiers (computation node IDs) from “0” to “N−1” are allocated to the respective computation nodes 100-1, 100-2, . . . , and 100-N.

The computation nodes 100-1, 100-2, . . . , and 100-N are, for example, computers connected to a network 20. The network 20 includes, for example, a plurality of switches 31, 32, . . . . The computation nodes 100-1, 100-2, . . . , and 100-N are connected to each other via the switches 31, 32, . . . .

Furthermore, a shared storage device 40 is connected to the network 20. The shared storage device 40 is a storage device that stores data used for machine learning (learning data). The shared storage device 40 is shared by the computation nodes 100-1, 100-2, . . . , and 100-N.

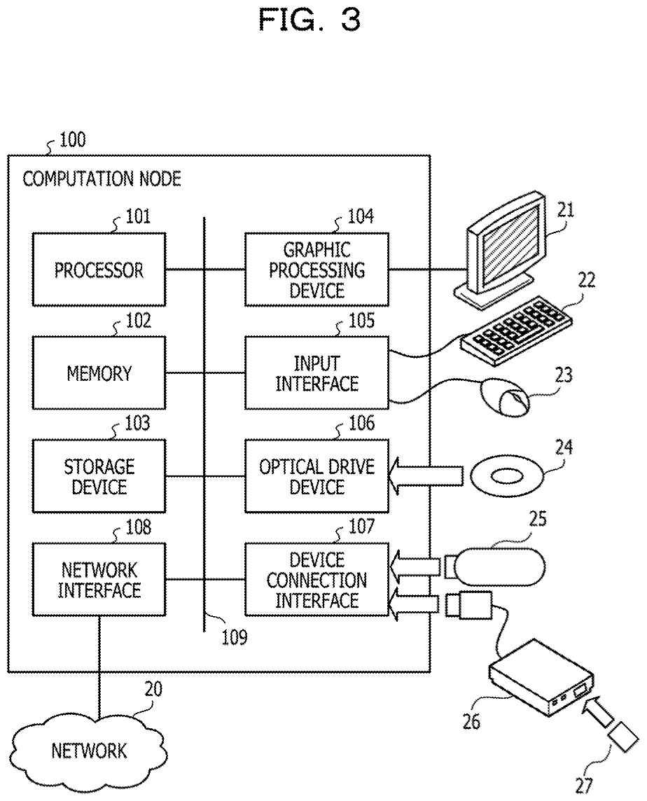

FIG. 3 is a diagram illustrating exemplary hardware of the computation node. In the computation node 100-1, the entire device is controlled by a processor 101. A memory 102 and a plurality of peripheral devices are connected to the processor 101 via a bus 109. The processor 101 may also be a multiprocessor. The processor 101 is, for example, a central processing unit (CPU), a micro processing unit (MPU), or a digital signal processor (DSP). At least a part of functions achieved by the execution of a program by the processor 101 may be achieved by an electronic circuit such as an application specific integrated circuit (ASIC) and a programmable logic device (PLD).

The memory 102 is used as a main storage device of the computation node 100-1. In the memory 102, at least a part of an operating system (OS) program and an application program to be executed by the processor 101 is temporarily stored. Furthermore, the memory 102 stores various types of data used in processing by the processor 101. As the memory 102, for example, a volatile semiconductor storage device such as a random access memory (RAM) is used.

The peripheral devices connected to the bus 109 include a storage device 103, a graphic processing device 104, an input interface 105, an optical drive device 106, a device connection interface 107, and a network interface 108.

The storage device 103 electrically or magnetically writes and reads data in and from a built-in recording medium. The storage device 103 is used as an auxiliary storage device of a computer. The storage device 103 stores the OS program, the application program, and various types of data. Note that, as the storage device 103, for example, a hard disk drive (HDD) or a solid state drive (SSD) may be used.

A monitor 21 is connected to the graphic processing device 104. The graphic processing device 104 displays an image on a screen of the monitor 21 in accordance with a command from the processor 101. Examples of the monitor 21 include a display device using organic electro luminescence (EL), and a liquid crystal display device.

A keyboard 22 and a mouse 23 are connected to the input interface 105. The input interface 105 transmits signals sent from the keyboard 22 and the mouse 23 to the processor 101. Note that the mouse 23 is an example of a pointing device, and other pointing devices may also be used. Other pointing devices include a touch panel, a tablet, a touch pad, and a track ball.

The optical drive device 106 reads data recorded on an optical disc 24 using laser light or the like. The optical disc 24 is a portable recording medium on which data is recorded so as to be readable by the reflection of light. Examples of the optical disc 24 include a digital versatile disc (DVD), a DVD-RAM, a compact disc read only memory (CD-ROM), and a CD-recordable (R)/rewritable (RW).

The device connection interface 107 is a communication interface for connecting the peripheral devices to the computation node 100-1. For example, a memory device 25 and a memory reader/writer 26 may be connected to the device connection interface 107. The memory device 25 is a recording medium equipped with a communication function with the device connection interface 107. The memory reader/writer 26 is a device that writes data in a memory card 27 or reads data from the memory card 27. The memory card 27 is a card type recording medium.

The network interface 108 is connected to the network 20. The network interface 108 exchanges data with another computer or a communication device via the network 20.

Note that the computation node 100-1 may not include the graphic processing device 104, the input interface 105, the optical drive device 106, or the device connection interface 107.

The computation node 100-1 may achieve a processing function according to the second embodiment with hardware as described above. The other computation nodes 100-2 to 100-N may also be achieved by hardware similar to the hardware of the computation node 100-1. Furthermore, the computation nodes 10, 10-1, . . . indicated in the first embodiment may also be achieved by hardware similar to the hardware of the computation node 100-1.

The computation node 100-1 achieves the processing function of the second embodiment by executing, for example, a program recorded on a computer-readable recording medium. A program in which processing contents to be executed by the computation node 100-1 are described may be recorded in a variety of recording media. For example, the program to be executed by the computation node 100-1 may be stored in the storage device 103. The processor 101 loads at least a part of the program in the storage device 103 onto the memory 102 and executes the program. Furthermore, the program to be executed by the computation node 100-1 may also be recorded on a portable recording medium such as the optical disc 24, the memory device 25, or the memory card 27. The execution of the program stored in the portable recording medium is enabled after being installed on the storage device 103, for example, under the control of the processor 101. In addition, the processor 101 may also read the program directly from the portable recording medium and execute the program.

Each of the computation nodes 100-1, 100-2, . . . , and 100-N reads the learning data from the shared storage device 40 and implements machine learning while synchronizing with each other. When the computation nodes 100-1, 100-2, . . . , and 100-N perform the synchronous parallel learning, the computation nodes 100-1, 100-2, . . . , and 100-N read the learning data from the shared storage device 40 at the same timing. For this reason, there is a possibility that communication congestion in the network 20, or waiting in the queue for reading from the shared storage device 40, or the like occur, and a delay in reading the learning data happens in some computation nodes. When the learning data is read from the shared storage device 40, a response delay occurs due to the influence of a program that performs processing other than the distributed deep learning, and the like. Such reading delays occur irregularly and are thus not easy to predict.

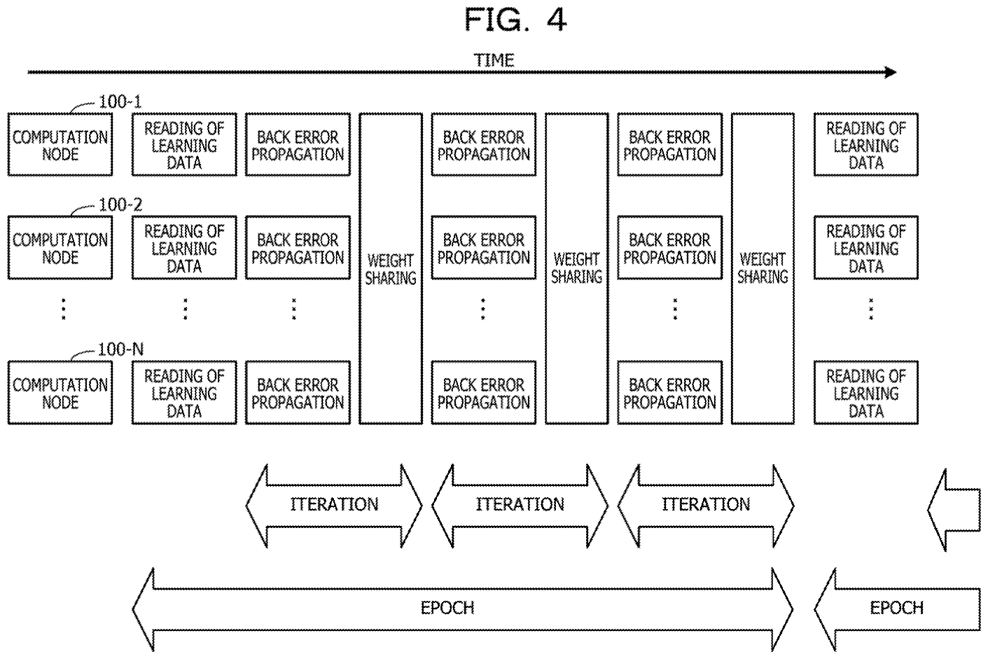

FIG. 4 is a diagram illustrating an exemplary procedure of the distributed deep learning. Each of the computation nodes 100-1, 100-2, . . . , and 100-N reads one piece of learning data from the shared storage device 40. Then, each of the computation nodes 100-1, 100-2, . . . , and 100-N performs deep learning processing based on the read learning data, and calculates a modification value for the error of the weight parameter set in the learning model (weight update value) by back error propagation. In the case of the neural network, the learning model includes a plurality of weight parameters, and the weight update value is calculated for each weight parameter.

At this time, the respective computation nodes 100-1, 100-2, . . . , and 100-N perform the deep learning based on different pieces of learning data, and different weight update values are calculated. Thus, the computation nodes 100-1, 100-2, . . . , and 100-N cooperate with each other to perform weight sharing processing. The weight sharing processing is processing of calculating a unified weight update value (common weight update value) based on the weight update value calculated by each of the computation nodes 100-1, 100-2, . . . , and 100-N, and updating the weight parameters of the learning models of the computation nodes 100-1, 100-2, . . . , and 100-N.

The computation nodes 100-1, 100-2, . . . , and 100-N repeatedly execute the weight update value calculation processing and the weight sharing processing on the read learning data by back error propagation. Here, the execution of the weight update value calculation processing and the weight sharing processing by back error propagation one time each is assumed as one iteration. The computation nodes 100-1, 100-2, . . . , and 100-N read the next learning data once a predetermined number of iterations are completed. Processing from the reading of the learning data to the completion of a predetermined number of iterations is called an epoch.

As illustrated in FIG. 4, the learning data is read at the same timing (at the time of starting one epoch) by the computation nodes 100-1, 100-2, . . . , and 100-N, and accordingly, a delay in reading the learning data occurs in some cases. At this time, if no measure is taken to restraint a delay in learning processing against a delay in reading the learning data, the entire processing will be delayed.

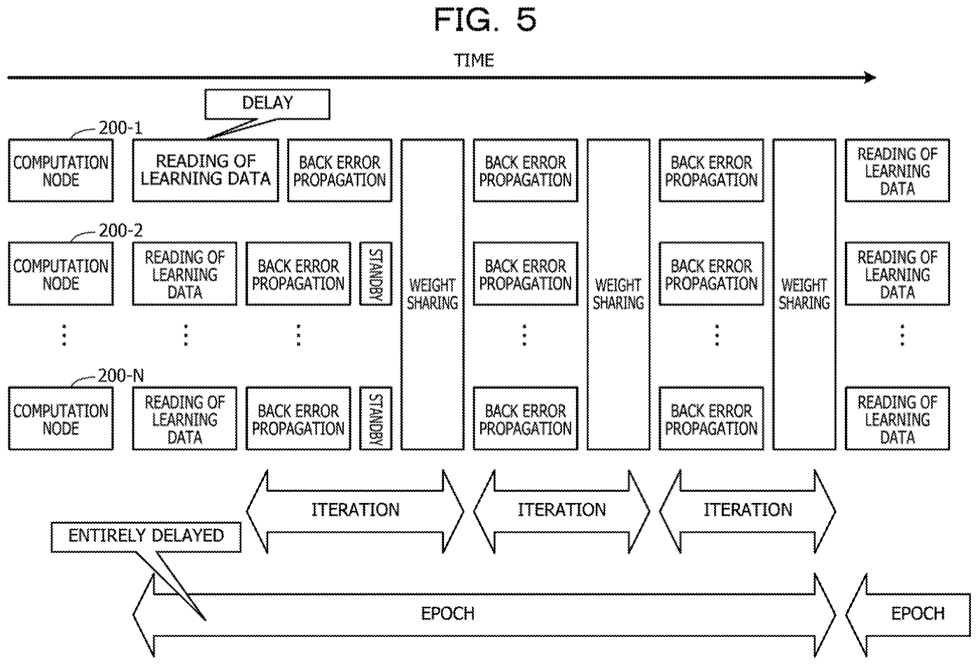

FIG. 5 is a diagram illustrating an exemplary procedure of the distributed deep learning in a case where processing of taking a measure against a data reading delay is not involved. In FIG. 5, it is assumed that the distributed deep learning is performed by parallel learning using a computation node 200-1 that does not have a function of restraining a delay in the entire processing against a data reading delay.

Here, a case where the computation node 200-1 is delayed in reading the learning data is presumed. In this case, the computation node 200-1 calculates the weight update value by back error propagation later than other computation nodes 200-2, . . . , and 200-N because of a delay in reading the learning data. The other computation nodes 200-2, . . . , and 200-N stand by until the calculation of the weight update value in the computation node 200-1 is completed. Then, once the computation node 200-1 calculates the weight update value, the computation nodes 200-1, 200-2, . . . , and 200-N cooperate with each other to start the weight sharing processing.

In this manner, due to a delay in reading the learning data in one computation node 200-1, the processing time of the initial iteration within the epoch is extended, and the processing of that epoch will also be completed late. This means that the influence of the data reading delay spreads over the entire system, and the degradation of performance occurs across the entire system. For example, when reading from the shared storage device 40 is performed, an unpredictable delay occurs.

Thus, in order to restrain the delay of the processing of the distributed deep learning by parallel learning, when a fixed amount or more of delay occurs in reading the learning data, the computation nodes 100-1, 100-2, . . . , and 100-N of the second embodiment proceed with the processing without waiting for the delayed learning data. For example, when a computation node in which a delay in reading the learning data has occurred or another computation node contains unlearned learning data, the delayed computation node uses the unlearned learning data as substitute learning data. Furthermore, when the delayed computation node or another computation node does not contain unlearned learning data, the computation node performs deep learning using learning data remaining in the cache. When no learning data remains in the cache, the computation node skips deep learning.

Consequently, the learning accuracy may be restrained from degrading while the delay of the entire learning process due to a delay in reading the learning data is relaxed.

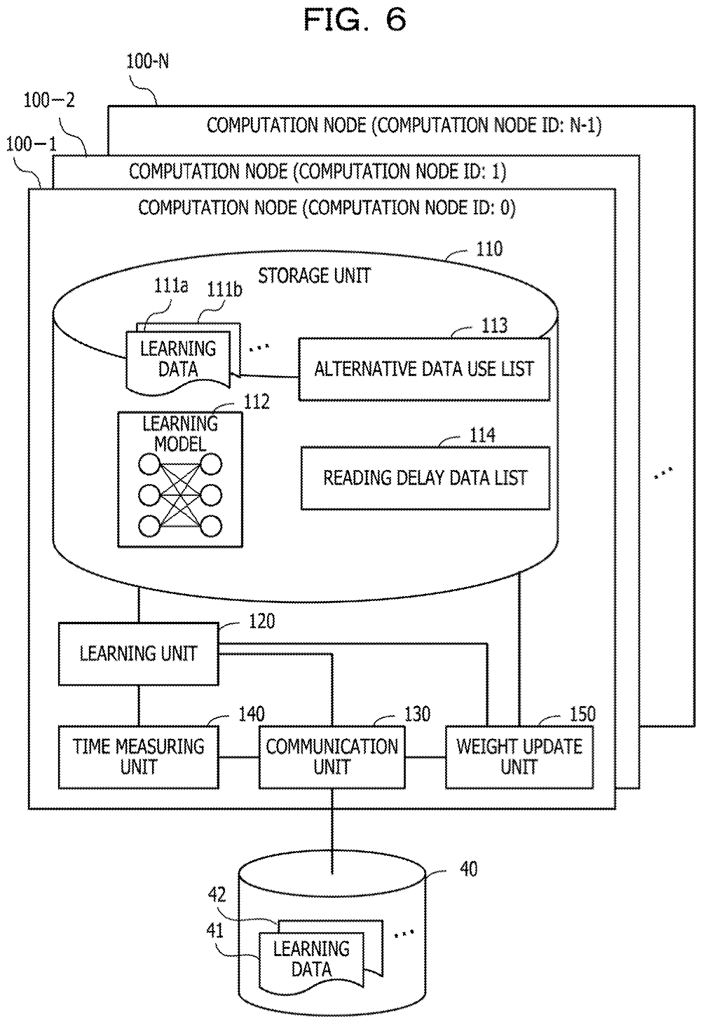

FIG. 6 is a block diagram illustrating a machine learning function in computation nodes. The computation node 100-1 includes a storage unit 110, a learning unit 120, a communication unit 130, a time measuring unit 140, and a weight update unit 150.

The storage unit 110 stores a plurality of pieces of learning data 111a, 111b, . . . , a learning model 112, an alternative data use list 113, and a reading delay data list 114. As the storage unit 110, for example, a part of the storage area of the memory 102 or the storage device 103 is used.

The pieces of learning data 111a, 111b, . . . are data that has been read from the shared storage device 40 for machine learning. Each of the pieces of learning data 111a, 111b, . . . includes input data, which is a target of processing using the learning model 112, and teacher data that indicates a correct answer of the processing result.

The learning model 112 is information trained by machine learning, which defines determination criteria for information analysis and the like. For example, in the deep learning, the learning model 112 includes the structure of the neural network and the value of the weight parameter that indicates the strength of coupling between neurons in the neural network.

The alternative data use list 113 is a data table that manages the number of times the learning data that has already been read is used as alternative data for learning data whose reading is delayed.

The reading delay data list 114 is a data table that manages learning data whose reading is delayed.

The learning unit 120 cooperates with other computation nodes 100-2 to 100-N to perform the distributed deep learning. For example, the learning unit 120 picks up and reads one piece of learning data that has not been used for learning in any of the computation nodes, via the communication unit 130, from among a plurality of pieces of learning data 41, 42, . . . stored in the shared storage device 40. At this time, the learning unit 120 acquires, from the time measuring unit 140, the elapsed time from the start of reading the learning data, and verifies whether or not the reading of the learning data has been completed within the threshold value for the reading time. If the reading of the learning data has been completed within the threshold value, the learning unit 120 stores the read learning data in the storage unit 110 and performs the learning using the stored learning data. Furthermore, when the reading of the learning data has not been completed even after the threshold value or more has elapsed, the learning unit 120 acquires alternative learning data, for example, from other than the shared storage device 40, and performs the learning using the alternative learning data. The alternative learning data is either one piece of the learning data 111a, 111b, . . . held by the computation node 100-1 in the own storage unit 110, or one piece of learning data held by other computation nodes. The learning unit 120 transmits the weight update value generated as a result of the deep learning to the weight update unit 150, or transmits the weight update value to the other computation nodes 100-2 to 100-N via the communication unit 130.

The communication unit 130 communicates with the other computation nodes 100-2 to 100-N or the shared storage device 40. For example, the communication unit 130 acquires the learning data from the shared storage device 40 in accordance with the instruction from the learning unit 120. Then, the communication unit 130 transmits the acquired learning data to the learning unit 120. Furthermore, the communication unit 130 transmits information that indicates the weight update value, to the other computation nodes 100-2 to 100-N in accordance with the instruction from the learning unit 120. In addition, when information that indicates the weight update value is acquired from the other computation nodes 100-2 to 100-N, the communication unit 130 transmits the acquired information to the weight update unit 150.

The time measuring unit 140 measures the learning data reading time by the communication unit 130. Then, the time measuring unit 140 notifies the learning unit 120 of the elapsed time for reading the learning data,

The weight update unit 150 updates the weight parameter of the learning model 112 based on the common weight update value, which is based on the weight update value obtained from the result of the deep learning executed on each of the plurality of computation nodes 100-1, 100-2, . . . , and 100-N. For example, the weight update unit 150 acquires the common weight update value calculated by any of the other computation nodes 100-2 to 100-N, and updates the weight parameter of the learning model 112 with the acquired common weight update value. Furthermore, the weight update unit 150 may also acquire the weight update values from the learning unit 120 and the other computation nodes 100-2 to 100-N to calculate the common weight update value based on the acquired weight update values. In this case, the weight update unit 150 updates the weight parameter of the learning model 112 with the common weight update value calculated by the weight update unit 150. In addition, the weight update unit 150 transmits the common weight update value calculated by the weight update unit 150 to the other computation nodes 100-2 to 100-N via the communication unit 130.

Note that, lines connecting the respective elements illustrated in FIG. 6 indicate a part of communication paths, and a communication path other than the illustrated communication paths may also be set. Furthermore, the function of each element illustrated in FIG. 6 may be achieved, for example, by allowing the computer to execute a program module corresponding to the element.

The computation nodes 100-2 to 100-N also have functions similar to the function of the computation node 100-1. Note that the computation of the common weight update value is only needed to be executed by any one of the computation nodes. In addition, the alternative data use list 113 and the reading delay data list 114 are also only needed to be included in any one of the computation nodes. A computation node that does not have the alternative data use list 113 and the reading delay data list 114 accesses the alternative data use list 113 and the reading delay data list 114 via the network 20.

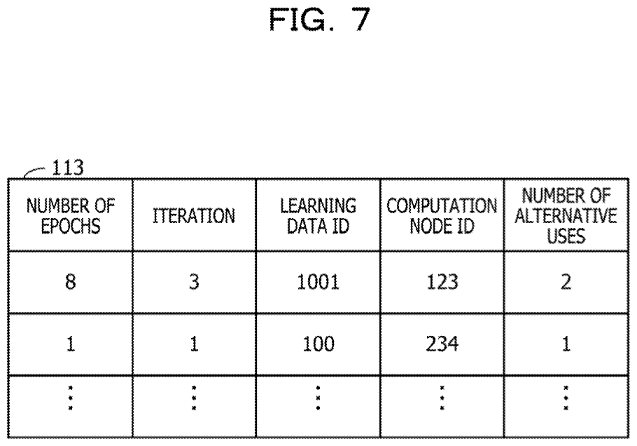

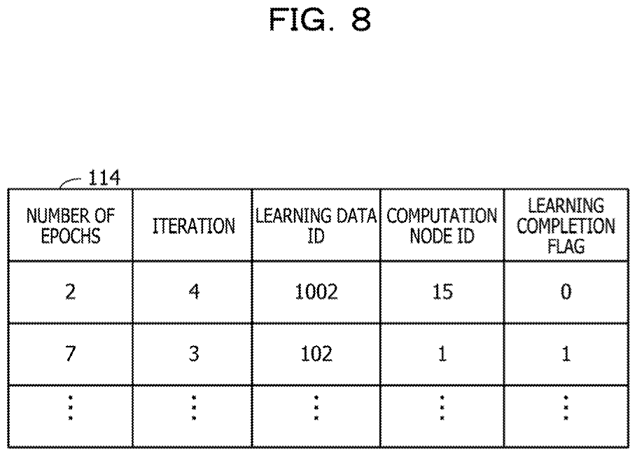

Next, the alternative data use list 113 and the reading delay data list 114 will be described in detail with reference to FIGS. 7 and 8, respectively.

FIG. 7 is a diagram illustrating an exemplary alternative data use list. In the alternative data use list 113, records relating to learning data used as alternative data are registered. The alternative data use list 113 is provided with columns for the number of epochs, iteration, learning data ID, computation node ID, and the number of alternative uses.

In the column of the number of epochs, what place an epoch in which the alternative data was read is positioned among epochs from the start of learning is set. In the column of iteration, the number of iterations executed for the alternative data is set. In the column of learning data ID, an identifier (learning data ID) of learning data used as alternative data is set. In the column of computation node ID, an identifier (computation node ID) of a computation node that holds learning data used as alternative data is set. In the column of the number of alternative uses, the number of times the learning data has been used as alternative data is set.

FIG. 8 is a diagram illustrating an exemplary reading delay data list In the reading delay data list 114, records relating to learning data for which a reading delay has occurred are registered. The reading delay data list 114 is provided with columns for the number of epochs, iteration, learning data ID, computation node ID, and learning completion flag.

In the column of the number of epochs, what place an epoch in which the learning data was read is positioned among epochs from the start of learning is set. In the column of iteration, the number of iterations executed for the learning data is set. In the column of learning data ID, the learning data ID of learning data for which a reading delay has occurred is set. In the column of computation node ID, the computation node ID of a computation node that has read the learning data for which a reading delay has occurred is set. In the column of learning completion flag, a flag (learning completion flag) that indicates whether or not learning using the learning data has been performed is set. For example, if the learning data has been used for learning, “1” is set for the learning completion flag, and if the learning data has not been used for learning, “0” is set for the learning completion flag.

With the configuration as described above, the computation nodes 100-1, 100-2, . . . , and 100-N cooperate with each other to perform the synchronous distributed deep learning. At this time, each of the computation nodes 100-1, 100-2, . . . , and 100-N measures the reading time when reading the learning data.

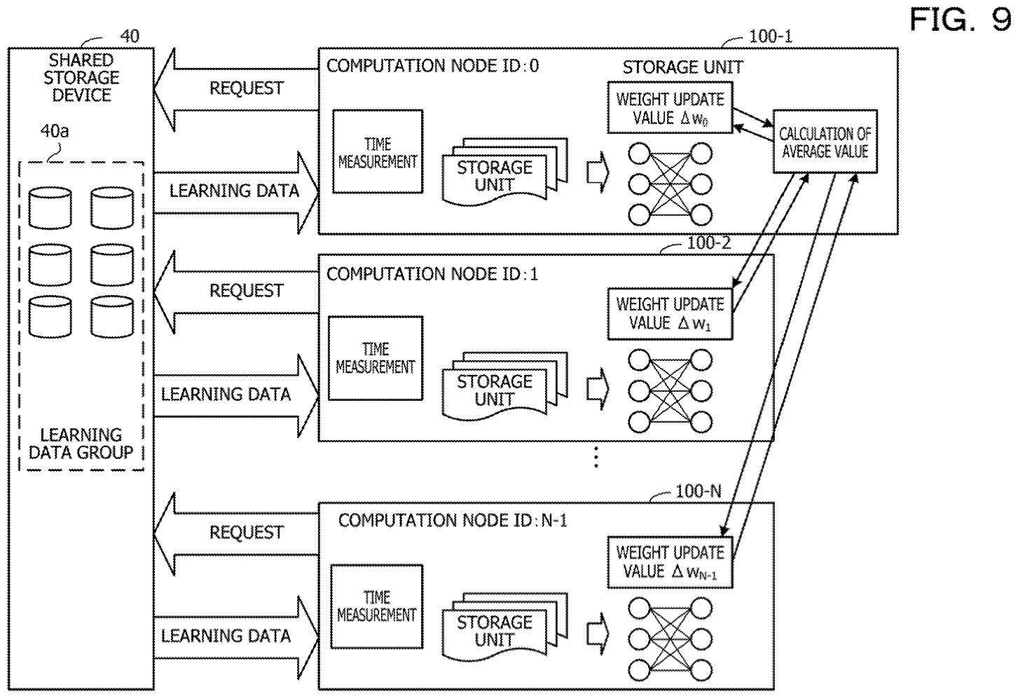

FIG. 9 is a diagram for explaining distributed deep learning processing that involves the measurement of learning data reading time. A learning data group 40a is stored in the shared storage device 40, and the computation nodes 100-1, 100-2, . . . , and 100-N each transmit, to the shared storage device 40, a request to read the learning data at the time of starting the epoch. The computation nodes 100-1, 100-2, . . . , and 100-N transmit requests in which pieces of learning data different from each other are designated.

The shared storage device 40 transmits learning data designated by a request transmitted from each of the computation nodes 100-1, 100-2, . . . , and 100-N in response to the relevant request. The computation nodes 100-1, 100-2, . . . , and 100-N each measure the time from the transmission of the request to the completion of the reception of the learning data.

The computation nodes 100-1, 100-2, . . . , and 100-N individually perform the deep learning using the own learning models held by the respective computation nodes, based on the read learning data, and calculate the weight update values (Δw₀, Δw₁, . . . , and Δw_{N-}1).

The calculated weight update values are put together in one computation node (in the example in FIG. 9, the computation node 100-1). For example, the computation nodes 100-2, . . . , and 100-N transmit information that indicates the weight update values, to the computation node 100-1. Furthermore, the computation nodes 100-2, . . . , and 100-N may also transmit information that indicates the weight update values, to a computation node other than the computation node 100-1. In that case, the computation node that has received the information that indicates the weight update values from the other computation nodes sums the own weight update value calculated by the computation node and the received weight update values, and transmits a summed weight update value to the computation node 100-1.

The computation node 100-1 that has received the weight update values of the computation nodes 100-2, . . . , and 100-N calculates the average value of all the weight update values, and specifies a common weight update value based on the average value. Then, the computation node 100-1 transmits the specified weight update value to the computation nodes 100-2, . . . , and 100-N. Subsequently, each of the computation nodes 100-1, 100-2, . . . , and 100-N updates the weight parameter of the learning model using the common weight update value specified as a unified value. For example, each of the computation nodes 100-1, 100-2, . . . , and 100-N adds the weight update value to the value of the weight parameter.

Note that the learning model includes a plurality of weight parameters, and the weight value update processing is performed for each weight parameter.

As illustrated in FIG. 9, the plurality of computation nodes 100-2, . . . , and 100-N simultaneously read the learning data from the shared storage device 40 at the epoch start timing. For this reason, waiting in the queue for processing in the shared storage device 40 or congestion of communication on the network 20 are likely to occur. Besides, there is a possibility that another device (not illustrated) is connected to the network 20, and it is difficult to predict in which computation node a delay in reading the learning data will occur.

Thus, each of the computation nodes 100-2, . . . , and 100-N counts the time for reading the learning data, and when it is verified that a delay will occur in the reading time, does not wait for the reading to complete but performs learning using the alternative data.

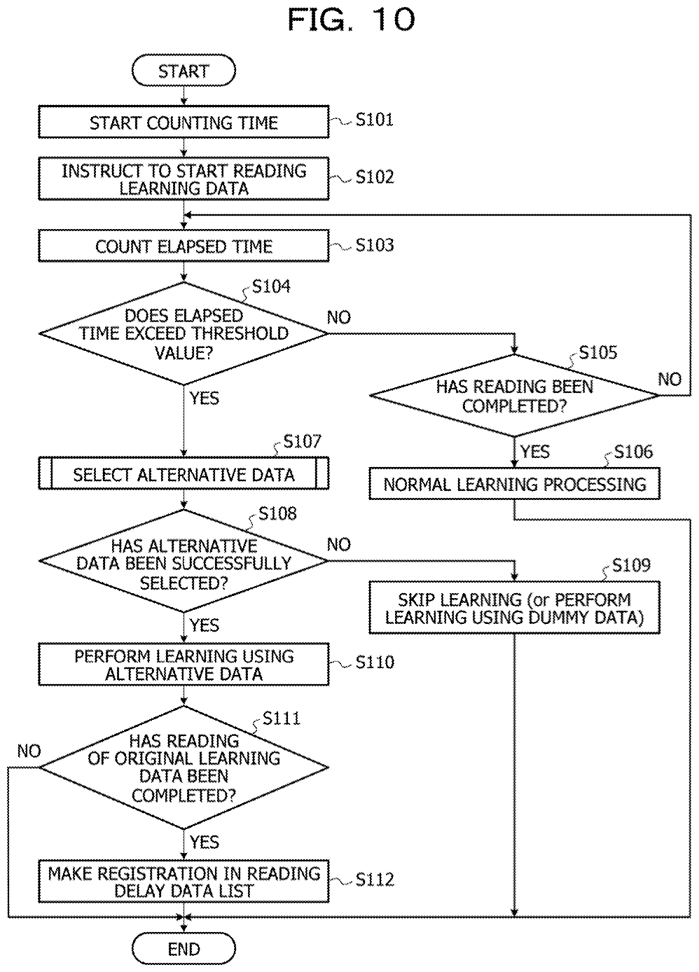

FIG. 10 is a flowchart illustrating an exemplary learning processing procedure in a computation node within one epoch. Hereinafter, by presuming that the computation node 100-1 executes the processing, the processing illustrated in FIG. 10 will be described along step numbers.

[Step S101]

Once the execution of the deep learning is started, the time measuring unit 140 starts counting the time at the time of starting the epoch.

[Step S102] The learning unit 120 instructs the communication unit 130 to start reading the learning data. The communication unit 130 starts reading the learning data from the shared storage device 40,

[Step S103] The time measuring unit 140 counts the elapsed time for reading the learning data by the communication unit 130. The time measuring unit 140 notifies the learning unit 120 of the measured elapsed time,

[Step S104] The learning unit 120 verifies whether or not the elapsed time exceeds the threshold value. When the elapsed time exceeds the threshold value, the learning unit 120 advances the processing to step S107. Meanwhile, if the elapsed time does not exceed the threshold value, the learning unit 120 advances the processing to step S105.

[Step S105] The learning unit 120 verifies whether or not the reading of the learning data has been completed. If the reading of the learning data has been completed, the learning unit 120 advances the processing to step S106. Meanwhile, if the reading of the learning data has not been completed, the learning unit 120 advances the processing to step S103.

[Step S106] The learning unit 120 uses the read learning data to perform normal learning processing for iterations executed in one epoch. Note that the learning unit 120 stores the read learning data in the storage unit 110. The learning data stored in the storage unit 110 is held in the storage unit 110 as cache data for a predetermined period.

In one iteration, the learning unit 120 employs the read learning data as an input to the learning model 112 to perform analysis in accordance with the learning model 112, and obtains a learning result. The learning unit 120 performs back error propagation based on the error between the learning result and the teacher data, and calculates the weight update value for each weight parameter in the learning model 112. In the back error propagation, a value expected to lessen the error between the learning result and the teacher data is generated as the weight update value. The learning unit 120 transmits the generated weight update value to the weight update unit 150.

The weight update unit 150 calculates the common weight update value based on the average of the weight update values generated by all the computation nodes 100-1, 100-2, . . . , and 100-N. The weight update unit 150 transmits the calculated weight update value to the computation nodes 100-2, . . . , and 100-N. Furthermore, the weight update unit 150 updates the weight parameter of the learning model 112 with the calculated weight update value.

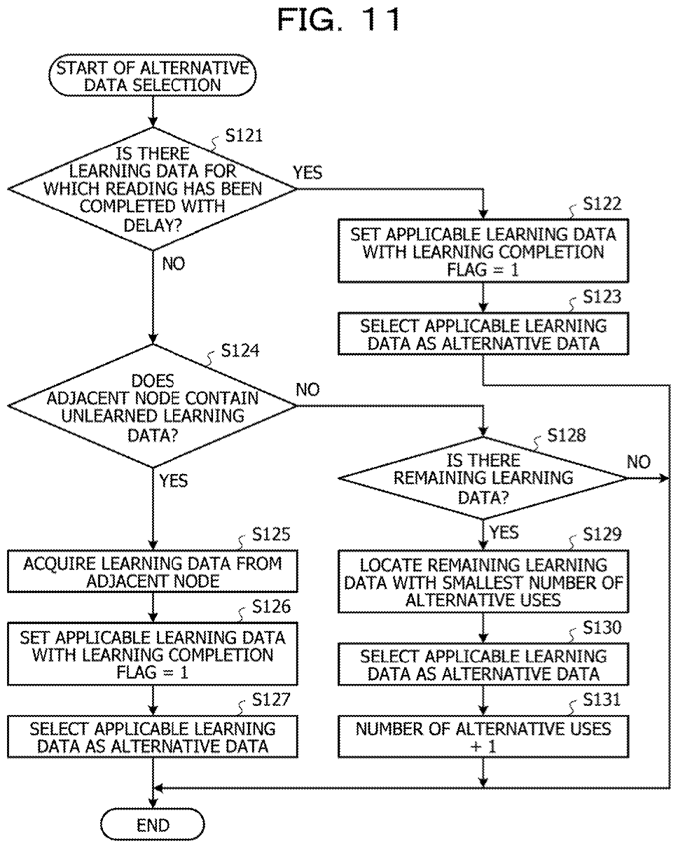

The learning unit 120 ends the learning processing for one epoch when the learning for a predetermined number of iterations ends.

[Step S107] The learning unit 120 performs processing of selecting alternative data that replaces the reading target learning data. Details of the alternative data selection processing will be described later (see FIG. 11).

[Step S108] The learning unit 120 verifies whether or not the alternative data has been successfully selected by the alternative data selection processing. When the alternative data has been successfully selected, the learning unit 120 advances the processing to step S110. Meanwhile, when the alternative data has not been successfully selected, the learning unit 120 advances the processing to step S109.

[Step S109] When there is no usable alternative data, the learning unit 120 does not conduct the learning for one epoch and skips the processing during that period. Note that, when there is dummy data prepared in advance, the learning unit 120 may perform learning using the dummy data. Thereafter, the learning unit 120 ends the learning for one epoch.

[Step S110] The learning unit 120 performs the learning processing for one epoch using the alternative data. Details of the learning processing are similar to those of the normal learning processing indicated in step S106, except that the learning data to be used is the alternative data.

[Step S111] The learning unit 120 verifies whether or not the reading of the original learning data has been completed. When the reading of the original learning data has been completed, the learning unit 120 advances the processing to step S112. Meanwhile, when the reading of the original learning data has not been completed, the learning unit 120 ends the learning for one epoch. Note that the learning data read with delay is stored in the storage unit 110.

[Step S112] The learning unit 120 registers, in the reading delay data list 114, a record corresponding to the learning data read with delay. At this time, the learning unit 120 sets “0” for the learning completion flag of the registered record. Thereafter, the learning unit 120 ends the learning for one epoch.

In this manner, when the reading of the learning data is delayed, the learning using the alternative data is enabled. The alternative data is selected by the alternative data selection processing.

FIG. 11 is a flowchart illustrating an exemplary procedure of the alternative data selection processing. Hereinafter, processing illustrated in FIG. 11 will be described along step numbers.

[Step S121] The learning unit 120 verifies whether or not the storage unit 110 contains unused learning data for which reading has been completed with delay. For example, the learning unit 120 refers to the reading delay data list 114, and when there is a record in which the own computation node ID “0” of the computation node 100-1 is set and the learning completion flag has “0”, verifies that there is unlearned learning data for which reading has been completed with delay. When there is applicable learning data, the learning unit 120 advances the processing to step S122. Meanwhile, when there is no applicable learning data, the learning unit 120 advances the processing to step S124.

[Step S122] The learning unit 120 sets “1” for the learning completion flag of the learning data for which reading has been completed with delay, in the reading delay data list 114.

[Step S123] The learning unit 120 selects the learning data for which reading has been completed with delay, as alternative data, and ends the alternative data selection processing.

[Step S124] The learning unit 120 verifies whether or not a computation node (hereinafter, sometimes also referred to as an adjacent node) that is adjacent in terms of the connection relationship on the network contains unlearned learning data. For example, the learning unit 120 refers to the reading delay data list 114, and when there is a record in which the computation node ID of the adjacent node is set and the learning completion flag has “0”, verifies that the adjacent node contains unlearned learning data. When the adjacent node contains unlearned learning data, the learning unit 120 advances the processing to step S125. Meanwhile, when the adjacent node does not contain unlearned learning data, the learning unit 120 advances the processing to step S128.

[Step S125] The learning unit 120 acquires one of pieces of the unlearned learning data of the adjacent nodes from the relevant adjacent node.

[Step S126] The learning unit 120 sets “1” for the learning completion flag of the acquired learning data in the reading delay data list 114.

[Step S127] The learning unit 120 selects the learning data acquired from the adjacent node, as alternative data, and ends the alternative data selection processing.

[Step S128] The learning unit 120 verifies whether or not the own computation node 100-1 has learning data remaining as cache data. When there is remaining learning data, the learning unit 120 advances the processing to step S129. Meanwhile, when there is no remaining learning data, the learning unit 120 ends the alternative data selection processing without selecting alternative data.

[Step S129] The learning unit 120 locates remaining learning data with the smallest number of alternative uses. For example, the learning unit 120 refers to the alternative data use list 113, and picks up a record with the smallest number of alternative uses, from among records in which the own computation node ID “0” of the computation node 100-1 is set. Then, the learning unit 120 locates learning data with the learning data ID indicated in the picked-up record.

[Step S130] The learning unit 120 selects the located learning data as alternative data.

[Step S131] The learning unit 120 adds “1” to the value of the number of alternative uses of the selected learning data in the alternative data use list 113,

In this manner, either the learning data included in the adjacent node or the learning data remaining in the own storage unit 110 included in the computation node may be selected as alternative data.

Note that, in order to execute step S124 of FIG. 11, it is stipulated in the learning unit 120 which computation node among the other computation nodes 100-2, . . . , and 100-N be assigned as the adjacent node. Whether or not the other computation nodes 100-2, . . . , and 100-N are regarded as adjacent nodes is verified based on the connection relationship on the network 20, for example.

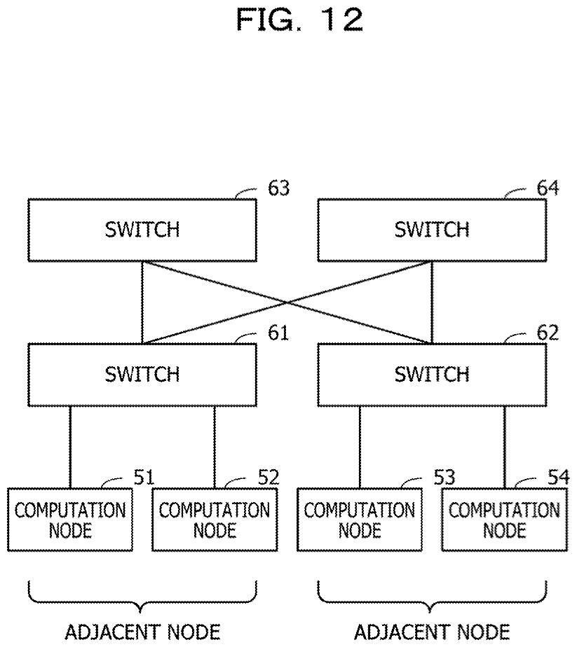

FIG. 12 is a diagram illustrating exemplary computation nodes regarded as adjacent nodes. In the example in FIG. 12, four computation nodes 51 to 54 are connected via four switches 61 to 64. The computation nodes 51 and 52 are both connected to the switch 61. The computation nodes 53 and 54 are both connected to the switch 62. The switches 61 and 62 are connected via the switch 63 or 54.

In the case of such a connection relationship, for example, the computation node 51 is allowed to acquire the alternative data from the computation node 52 via only the switch 61. Besides, the communication between the computation nodes 51 and 52 connected to the same switch 61 is not affected by the communication between the other computation nodes, and there is a low possibility that a data transfer delay will occur. Thus, the computation nodes 51 and 52 directly connected to the switch 61 are treated as adjacent nodes to each other. Similarly, the computation nodes 53 and 54 directly connected to the switch 62 are treated as adjacent nodes to each other.

When the learning unit 120 determines the adjacent nodes as described above, the storage unit 110 stores in advance information that indicates the network connection relationship (network topology). The learning unit 120 refers to the network topology to verify which computation node among the other computation nodes 100-2, . . . , and 100-N is regarded as the adjacent node.

By taking into consideration the network connection relationship and assigning a computation node in which a communication delay is unlikely to occur, as an adjacent node, the alternative data may be reliably acquired in a short time. For example, since the reading from the adjacent node is performed in a situation where a delay has already occurred, further delay is not allowable. Therefore, the learning unit 120 assigns, as an adjacent node, a node present within a range where there is no influence from others, such as collision, in communication. As a result, the influence of a delay in reading the learning data from the shared storage device 40 may be minimized. Note that, when the upper switches are connected to each other at an exceptionally high speed and a bottleneck is not produced even if all nodes communicate with each other, the learning unit 120 may assign all the other computation nodes 100-2, . . . , and 100-N as adjacent nodes.

In addition, as illustrated in FIG. 9, the common weight update value is calculated according to the average value of the weight update values for each iteration, but when there is a computation node that has skipped the learning, the weight update unit 150 may lower the common weight update value (the modification amount of the weight parameter). Furthermore, in the synchronous distributed deep learning example illustrated in FIG. 4, the weight sharing processing is performed every time the learning using one piece of learning data is conducted; however, the weight sharing processing also may be performed after each of the computation nodes 100-1 to 100-N individually conducts the learning using a plurality of pieces of learning data. In that case, the weight update unit 150 may change the degree of influence of the weight update value calculated by a certain computation node on the common weight update value, according to the number of pieces of learning data that have been learned without skipping among a plurality of pieces of learning data supposed to be learned in the certain computation node.

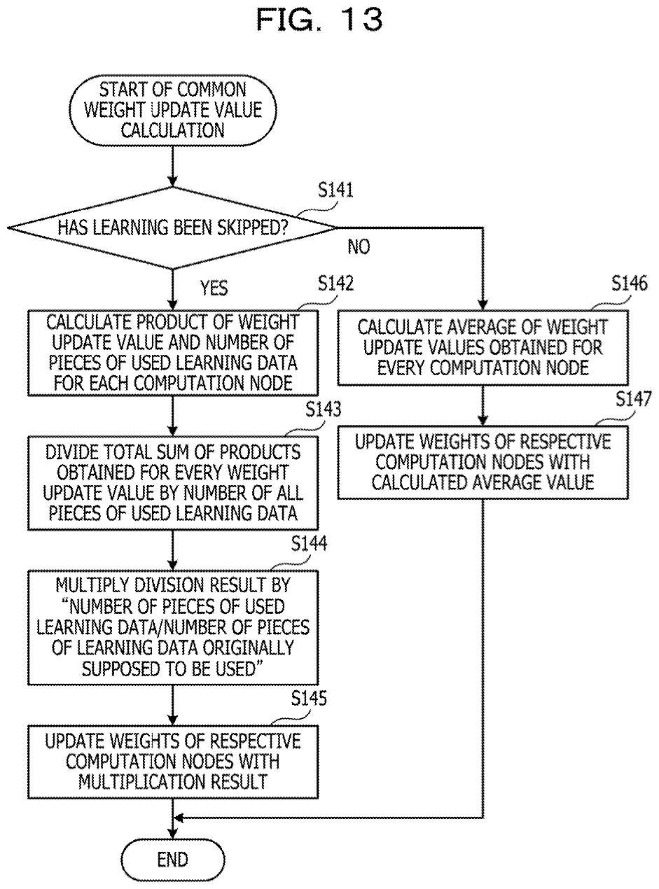

FIG. 13 is a flowchart illustrating an exemplary procedure of common weight update value calculation processing. Hereinafter, processing illustrated in FIG. 13 will be described along step numbers.

[Step S141] The weight update unit 150 verifies whether or not the learning has been skipped in any of computation nodes from the last time of weight sharing processing to this time of weight sharing processing. For example, when receiving information that indicates the weight update value from each computation node, the weight update unit 150 acquires the number of pieces of learning data used for calculating the weight update value from each computation node. The weight update unit 150 verifies that the learning has been skipped, if there is at least one computation node for which the acquired number of pieces of learning data is less than a predetermined value. When the learning has been skipped, the weight update unit 150 advances the processing to step S142. Meanwhile, if the learning has not been skipped, the weight update unit 150 advances the processing to step S146.

[Step S142] For each weight update value acquired from each computation node, the weight update unit 150 calculates the product of the weight update value and the number of pieces of learning data used for calculating that weight update value.

Note that the product of the weight update value and the number of pieces of learning data may be computed by a computation node that has calculated the weight update value. In that case, the weight update unit 150 that is to calculate the common weight update value computes the product of the weight update value calculated by the learning unit 120 of the computation node 100-1 and the number of pieces of learning data. Furthermore, the weight update unit 150 acquires the computation result for the product of the weight update value and the number of pieces of learning data from each of the other computation nodes 100-2, . . . , and 100-N.

[Step S143] The weight update unit 150 divides the total sum of the products obtained for every weight update value by the total number of pieces of learning data used for learning. The total number of pieces of learning data means the summed number of pieces of learning data used by all of the computation nodes 100-1, 100-2, . . . , and 100-N to calculate the weight update values.

[Step S144] The weight update unit 150 multiplies the division result in step S143 by “the number of pieces of used learning data/the number of pieces of learning data originally supposed to be used”. The number of pieces of learning data originally supposed to be used is a value obtained by multiplying the number of pieces of learning data used by the computation nodes to calculate the weight update values when the learning is not skipped, by he number of computation nodes.

Note that, when a learning rate is set for each epoch, for example, the weight update unit 150 multiplies the division result in step S143 by “the number of pieces of used learning data/the number of pieces of learning data originally supposed to be used” and the learning rate of the epoch currently being processed. For example, the learning rate for each epoch has a smaller value as the place of the epoch is later in the execution order. With this setting, the weight parameter is significantly modified immediately after the start of deep learning, and as deep learning progresses, the modification amount of the weight parameter becomes smaller. As a result, an extended duration of learning attributable to the value of the weight parameter that does not converge for a long time may be restrained.

[Step S145] The weight update unit 150 specifies the multiplication result in step S144 as the common weight update value, and updates the weight parameters of the learning models included in the respective computation nodes 100-1, 100-2, . . . , and 100-N, with the common weight update value.

For example, the weight update unit 150 transmits the common weight update value to the other computation nodes 100-2, . . . , and 100-N. Then, the weight update unit of each of the other computation nodes 100-2, . . . , and 100-N updates the weight parameter of the learning model in the own computation node. The weight update unit 150 updates the weight parameter of the learning model 112 of the computation node 100-1 stored in the storage unit 110 with the common weight update value. Thereafter, the common weight update value calculation processing ends.

[Step S146] The weight update unit 150 calculates the average of the weight update values calculated for each computation node. Note that, when the learning rate is set for each epoch, the weight update unit 150 multiplies the average of the weight update values by the learning rate of the epoch currently being processed, for example.

[Step S147] The weight update unit 150 specifies the average value calculated in step S146 as the common weight update value, and updates the weight parameters of the learning models included in the respective computation nodes 100-1, 100-2, and 100-N, with the common weight update value. Details of the update processing are similar to those in step S145. Thereafter, the common weight update value calculation processing ends.

In this manner, when there is a computation node that has skipped the learning, the common weight update value is lowered according to the number of pieces of learning data for which the learning has been skipped. For example, by heighten the common weight update value for this time of iteration as a larger number of pieces of learning data are used for learning, the learning efficiency of deep learning may be improved.

Next, a method of specifying a threshold value for detecting a reading delay will be described in detail.

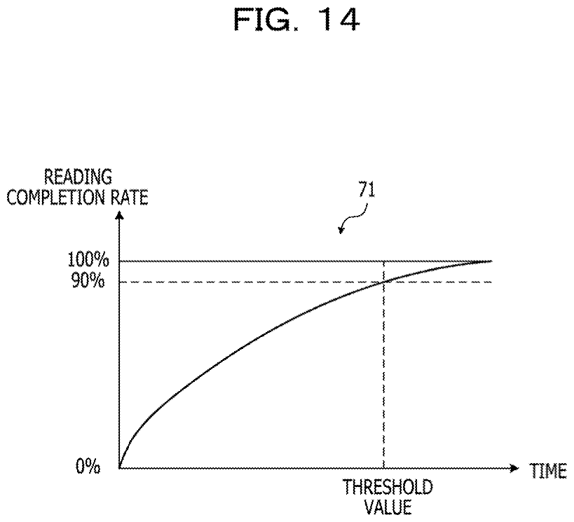

FIG. 14 is a diagram illustrating an exemplary method of specifying a threshold value for detecting a reading delay. The learning unit 120 employs, as a threshold value for detecting a reading delay, a time within which the reading is completed, for example, for 90% of pieces of learning data, among respective times taken to read a plurality of pieces of learning data.

In FIG. 14, the relationship between the reading time of the learning data and a reading completion rate is illustrated as a graph 71. For example, the learning unit 120 may generate the graph 71 as illustrated in FIG. 14 based on measurement results for past reading times of learning data. The horizontal axis of the graph 71 denotes the time from the start of reading the learning data, and the vertical axis denotes the learning data reading completion rate at the relevant time. The reading completion rate represents the percentage of the learning data for which reading has been completed by the corresponding time in the learning data that has been read. Note that the reading completion rate is a statistical value worked out from measurement results when a large number of pieces of learning data were read.

For example, the learning unit 120 employs a time when the reading completion rate matches 90% in the graph 71 as illustrated in FIG. 14, as a reading delay threshold value.

Note that the learning unit 120 may also dynamically change the threshold value. For example, the learning unit 120 puts aside information for the latest n instances (n is an integer equal to or greater than one) in the history of the learning data reading times, and dynamically calculates the threshold value based on the history for the latest n instances. The learning unit 120 may be allowed to accumulate the history for n instances by processing without setting the threshold value until the learning data reading history for n instances is accumulated.

As described above, in the second embodiment, when a delay occurs in reading the learning data, the learning for the next iteration is started without waiting for the completion of the reading of the delayed learning data. Therefore, the waiting time for reading the learning data whose reading is delayed is diminished, and the processing efficiency may be enhanced.

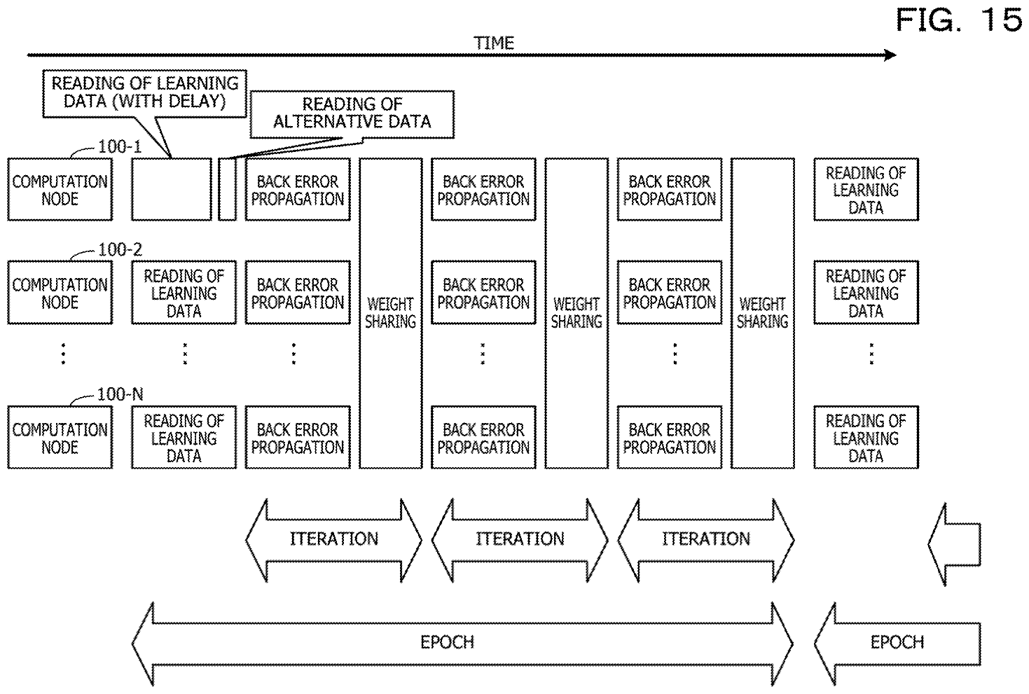

FIG. 15 is a diagram illustrating an exemplary distributed deep learning procedure that involves a measure to restrain a learning delay against a data reading delay. In the example in FIG. 15, a reading delay occurs when the computation node 100-1 reads the learning data. In this case, once it is detected that a delay has occurred in reading the learning data, the learning unit 120 of the computation node 100-1 reads the alternative data. The alternative data is stored in the computation node 100-1 or an adjacent node and may be read in a short time. Consequently, the plurality of computation nodes 100-1, 100-2, . . . , and 100-N may execute the learning processing by back error propagation without delay.

In this manner, by performing learning using the alternative data in the computation node 100-1 in which a delay has occurred in reading the learning data, the extension of the time until the generation of the learning model ends may be restrained.

Note that the computation nodes 100-1, 100-2, . . . , and 100-N sometimes continue the learning until, for example, an error in the analysis result for the learning data according to the learning model falls to or below a predetermined value. In that case, when the reading of the learning data is delayed, learning using the alternative data increases the degree of improvement in the accuracy of the learning model in one iteration, and shortens the time until the learning ends, rather than skipping the learning.

Furthermore, since the learning unit 120 restricts the destination from which the alternative data is acquired, to the adjacent node, a delay in reading the alternative data is restrained, and the learning using the alternative data may be reliably executed. Moreover, the learning unit 120 preferentially picks up learning data with a smaller number of alternative uses, as alternative data. Consequently, this may raise the learning efficiency in one epoch. For example, when the learning is repeated using the same learning model, the degree of improvement in the accuracy of the learning model by one time of learning is degraded as the number of repetitions increases. For this reason, by employing, as alternative data, learning data that has been used for learning fewer times in the past to a feasible extent, the degree of improvement in the accuracy of the learning model by the learning using the alternative data may be raised.

### Other Embodiments

The second embodiment uses the deep learning as an example, but a measure against a delay in reading the learning data indicated in the second embodiment may be applied to machine learning other than the deep learning.

The embodiments are illustrated as described above. However, the configuration of each portion described in the embodiments may be replaced with another having a similar function. Furthermore, any other components and steps may be added. Moreover, any two or more configurations (features) of the above-described embodiments may be combined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing system comprising:
a storage device configured to store a plurality of pieces of learning data; and
a plurality of computation nodes each configured to read learning target learning data from the storage device, determine whether or not a delay in reading the learning target learning data has occurred, based on a reading status, and when determining that the delay in reading has occurred, perform machine learning by synchronous parallel processing using alternative learning data previously read from the storage device.

2. The information processing system according to claim 1, wherein
the plurality of computation nodes each determines that the delay in reading has occurred, in a case where reading of the learning target learning data is not completed even when an elapsed time from a start of reading the learning target learning data reaches a threshold value that has been predetermined.

3. The information processing system according to claim 2, wherein
the plurality of computation nodes assigns, as the threshold value, a time within which reading of a predetermined percentage of the learning data is completed, the time being worked out based on a time taken to complete reading when the learning data was read in the past.

4. The information processing system according to claim 1, wherein
a first computation node that has determined that the delay in reading has occurred selects the alternative learning data from among pieces of learning data that have been read from the storage device and stored in the past by a part of the plurality of computation nodes.

5. The information processing system according to claim 4, wherein
the first computation node selects, as the alternative learning data, learning data for which reading has been completed after it is determined that the delay in reading has occurred in reading processing for previous learning data in the first computation node, and is not yet used for learning.

6. The information processing system according to claim 4, wherein
the first computation node selects, as the alternative learning data, learning data held by a second computation node that has a predetermined connection relationship with the first computation node, from the second computation node.

7. The information processing system according to claim 6, wherein
the first computation node assigns a computation node connected to a same switch as the first computation node, as the second computation node.

8. The information processing system according to claim 4, wherein
when the plurality of computation nodes contains a plurality of pieces of learning data that is allowed to be assigned as the alternative learning data, the first computation node selects the alternative learning data based on the number of times the learning data that is allowed to be assigned as the alternative learning data is used for learning.

9. The information processing system according to claim 1, wherein
in a case where there is no learning data that is allowed to be assigned as the alternative learning data when it is determined that the delay in reading has occurred, an applicable one of the plurality of computation nodes skips learning until a next learning data reading timing, and updates a value of a weight parameter commonly set in respective learning models included in the plurality of computation nodes, with a weight update value calculated according to a number of pieces of learning data used for learning without skipping.

10. The information processing system according to claim 9, wherein
the plurality of computation nodes employs, as the weight update value, a value obtained by multiplying an average of the weight update values computed by respective computation nodes that have executed learning without skipping, by a larger value as a number of pieces of learning data used for learning grows larger.

11. An information processing apparatus comprising:
a memory; and
a processor coupled to the memory and configured to:
read learning target learning data from a storage device that stores a plurality of pieces of learning data;
determine whether or not a delay in reading the learning target learning data has occurred, based on a reading status; and
when determining that the delay in reading has occurred, perform machine learning by synchronous parallel processing using alternative learning data previously read from the storage device.

12. A non-transitory computer-readable recording medium having stored therein an information processing program
for causing a computer to execute a process comprising:
reading learning target learning data from a storage device that stores a plurality of pieces of learning data;
determining whether or not a delay in reading the learning target learning data has occurred, based on a reading status; and
performing, when determining that the delay in reading has occurred, machine learning by synchronous parallel processing using alternative learning data previously read from the storage device.
